(19) United States
(12) Patent Application Publication
(10) Pub. No.: US 2004/0059735 A1
(43) Pub. Date: Mar. 25, 2004

(54) Systems and methods for enabling failover in a distributed-object computing environment

(76) Inventors: Russell Eliot Gold, Bala Cynwyd, PA (US); Gregory Pavlik, Trail Shamong, NJ (US)

Correspondence Address: HEWLETT-PACKARD COMPANY, Intellectual Property Administration, P. O. Box 272400, Fort Collins, CO, 80527-2400, US

(21) Appl. No.: 10/241,064

(22) Filed: Sep. 10, 2002

(51) Int. Cl. G06F 7/00

(52) U.S. Cl. 707/100

(57) ABSTRACT

Systems and methods for enabling failover are provided. An embodiment of a method for enabling failover comprises determining that an attempt to communicate with a first object having a first address has failed, the first object being a part of a first application hosted by a first application-server, requesting a backup address associated with a duplicate application that is substantially a copy of the first application, the duplicate application comprising a duplicate object that is substantially a copy of the first object, receiving the backup address, and using a portion of the first address and a portion of the backup address to construct a failover address for the duplicate object.

### FIELD OF THE INVENTION

The present invention generally relates to distributed-object computing environments. More particularly, the invention relates to systems and methods for enabling failover in distributed-object computing environments.

### DESCRIPTION OF THE RELATED ART

Communication failures often occur in a distributed-object computing environment (“DOCE”). The process of switching to a backup server in the event of a communication failure with a first server is often referred to as “failover.” Failover in a DOCE may be implemented pursuant to instructions from the application-client that experiences the failed communication. This failover approach, however, is inefficient since each application-client that implements failover would need to be separately programmed to enable failover. Another approach for enabling failover may be to provide a failover server that receives and forwards all messages between an application-client and an application-server. According to this approach, when an application-server fails, the failover server would forward messages to a backup server instead of to the failed server. This approach undesirably increases communication overhead in a DOCE since messages between application-clients and application-servers travel to and from the failover server. Therefore, there exists a need for improved systems and methods for enabling failover.

### SUMMARY OF THE INVENTION

The invention provides systems and methods for enabling failover. An embodiment of a method for enabling failover comprises determining that an attempt to communicate with a first object having a first address has failed, the first object being a part of a first application hosted by a first application-server, requesting a backup address associated with a duplicate application that is substantially a copy of the first application, the duplicate application comprising a duplicate object that is substantially a copy of the first object, receiving the backup address, and using a portion of the first address and a portion of the backup address to construct a failover address for the duplicate object.

An embodiment of a system for enabling failover comprises means for determining that an attempt to communicate with a first object has failed, the first object having a first address comprising a first object identifier (ID) and being part of a first application hosted by a first application-server, and means for constructing a failover address for a duplicate object having a same object ID as the first object, the duplicate object being part of a duplicate application hosted by a backup application-server.

### BRIEF DESCRIPTION OF THE DRAWINGS

Systems and methods for enabling failover are illustrated by way of example and not limited by the implementations illustrated in the following drawings. The components in the drawings are not necessarily to scale, emphasis instead is placed upon clearly illustrating the principles of the present invention. Moreover, in the drawings, like reference numerals designate corresponding parts throughout the several views.

FIG. 1 is a block diagram illustrating an embodiment of a failover system according to the present invention.

FIG. 2 is a flow chart illustrating an embodiment of a failover method according to the present invention.

FIG. 3 is a block diagram illustrating an example of a specific implementation of the failover system shown in FIG. 1.

FIG. 4 is a block diagram illustrating an embodiment of a computer network for implementing the failover system shown in FIG. 1.

FIG. 5 is a block diagram illustrating another embodiment of a failover system according to the present invention.

FIG. 6 is a flow chart illustrating a further embodiment of a failover method according to the present invention.

FIG. 7 is a block diagram illustrating an example of a specific implementation of the failover system shown in FIG. 5.

FIG. 8 is a block diagram illustrating an embodiment of a computer network for implementing the failover system shown in FIG. 5.

FIG. 9 is a functional block diagram illustrating an embodiment of a processing system that may be used to store and execute software implementations of the present invention.

### DETAILED DESCRIPTION

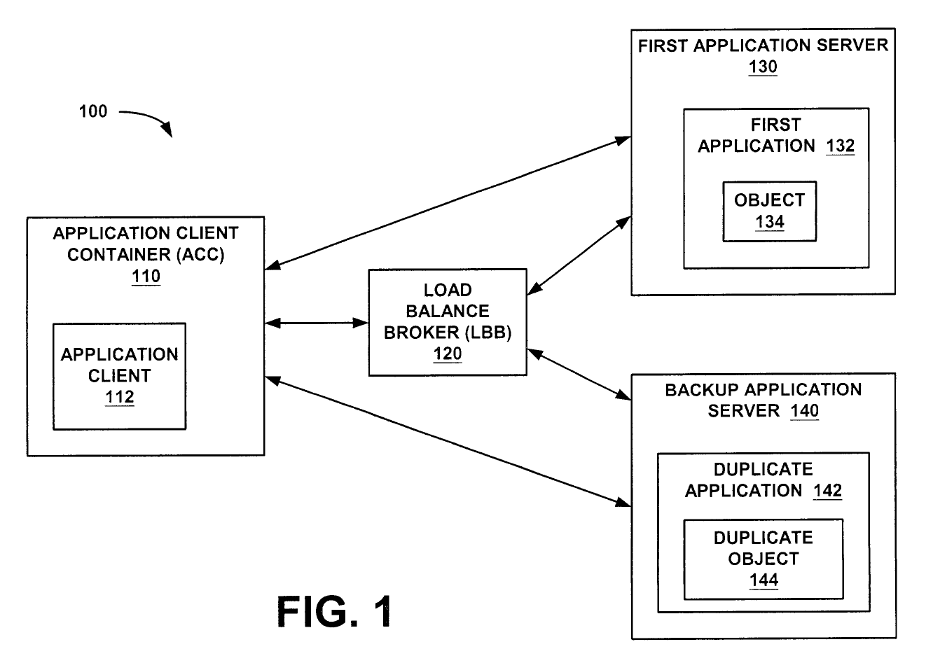

Reference is first directed to FIG. 1, which is a block diagram illustrating an embodiment of a failover system 100, according to the present invention. The failover system 100 comprises an application-client container (ACC) 110, an application-client 112, a load balance broker (LBB) 120, a first application-server 130, and a backup application-server 140, a first application 132, and a duplicate application 142, all of which are preferably software entities executed by respective computers. The first application-server 130 hosts a first application 132 comprising at least a first object 134. The backup application-server 140 hosts a duplicate application 142 that is substantially a copy of the first application 132. The duplicate application 142 comprises a duplicate object 144 that is substantially a copy of the first object 134.

The LBB 120 maintains a list of addresses for application-servers for the purpose of balancing workloads among the application-servers. The LBB 120 may enable failover by providing the ACC 110 with an address for the duplicate application 142 when a communication between the application-client 112 and the first object 134 fails. In an alternative embodiment, a software module other than the LBB 120 may be used to provide the ACC 110 with an address for the duplicate application 142.

The first application-server 130 and the backup application-server 140 each host at least one respective application in accordance with a standard that is now known or later developed. In a preferred embodiment, the first application-server 130 and the backup application-server 140 are Java modules that function in accordance with Java 2 Enterprise Edition platform (J2EE). The J2EE platform is a set of specifications, patterns and practices that define distributed, multi-tiered application development, deployment and management for the Java programming language.

The application-client 112 may communicate with the first application 132 and/or the duplicate application 142 by following a protocol that is now known or later developed. In a preferred embodiment, the ACC 110 communicates with the first object 134 and/or the duplicate object 144 via object request brokers (ORBs). Such ORBs are preferably compliant with common object request broker architecture (CORBA), which has been sanctioned by the International Organization for Standardization (ISO) as the standard architecture for distributed-objects.

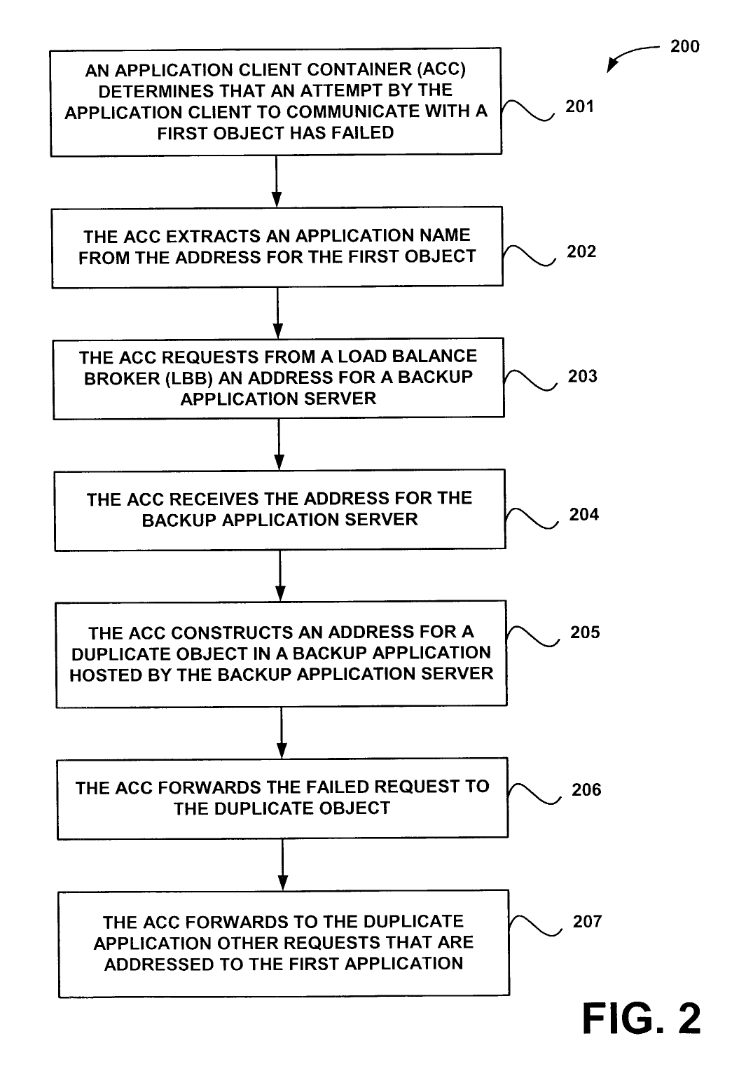

Reference is now directed to FIG. 2, which is a flow chart illustrating an embodiment of a failover method 200, according to the present invention. As shown in block 201, an ACC 110 that hosts an application-client 112 determines that an attempt by the application-client 112 to communicate with the first object 134 has failed. The ACC 110 may determine that the attempt to communicate has failed by determining that a response to a request by the application-client 112 was not received from the first object 134. In response to determining that the communication attempt has failed, the ACC 110 extracts the name of the first application 132 from an address for the first object 134, as illustrated in block 202.

Prior to extracting the name of the first application 132 from the address, the ACC 110 may determine whether the address comprises such name by determining whether the address comprises an application marker. The application marker, which may comprise certain character(s) that are positioned at predetermined location(s) in the address, may have been included in the address to indicate that the address comprises an application name that can be used to help locate a duplicate application 142. If the address does not comprise an application marker, then such address may not be manipulated to construct a failover address corresponding to a duplicate object.

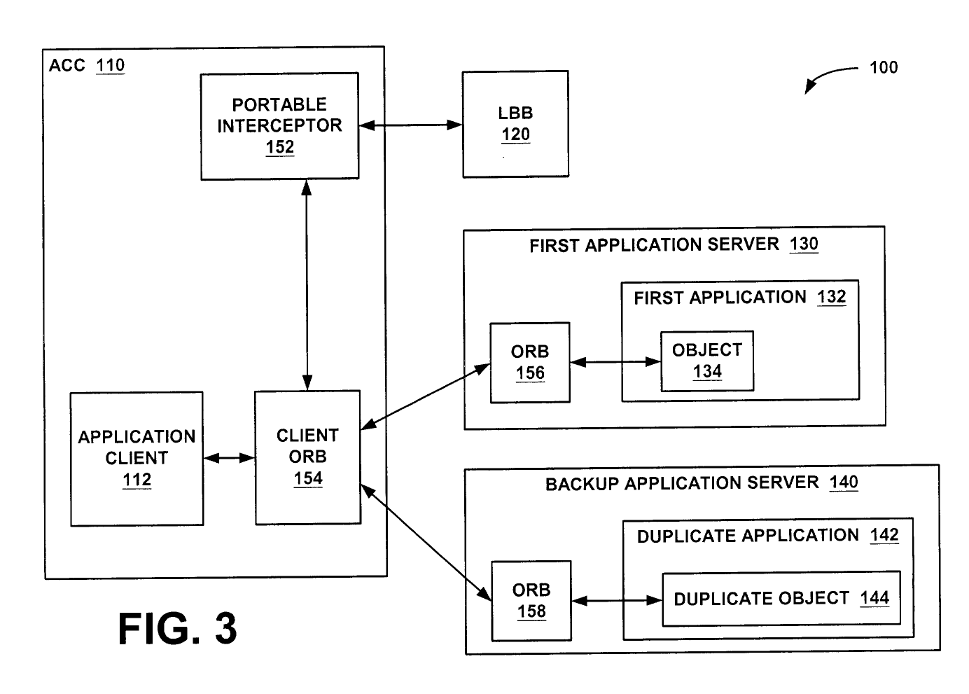

After extracting the application name from the address for the first object 134, the ACC 110 then requests from an LBB 120, as illustrated in block 203, a backup address corresponding to a duplicate application (i.e., an application that is substantially a copy of the first application 132). The duplicate application may be identified to the LBB 120 by the application name extracted from the address for the first object 134. In response to the request from the ACC 110, the LBB 120 provides the ACC 110 with the requested backup address, which may be obtained by the LBB 120 from the backup application server 140. After the ACC 110 receives the backup address, as illustrated in block 204, the ACC 110 uses the backup address to construct a failover address corresponding to a duplicate object 144 that is part of the duplicate application 142, as illustrated in block 205. A failover address may be constructed, for example, as discussed below in reference to FIG. 3. Note that the duplicate application 142 is substantially a copy of the first application 132 and that the duplicate object 144 is substantially a copy of the first object 134. A software entity is said to be substantially a copy of another software entity if both software entities are capable of performing a certain function. After constructing the failover address, the ACC 110 may then use it to forward a copy of a failed request to the duplicate object 144, as illustrated in block 206. Furthermore, the ACC 110 may forward to the duplicate application 142 copies of other requests from the application-client 112 that are addressed to the first application 132, as illustrated in block 207.

Reference is now directed to FIG. 3, which is a block diagram illustrating an example of a specific implementation of the failover system 100. The ACC 110 comprises a portable interceptor 152 and a client ORB 154 for providing services to the application-client 112. Furthermore, the first application-server 130 and the backup application-server 140 comprise server ORB 156 and server ORB 158, respectively. The portable interceptor 152, the client ORB 154, and the server ORBs 156 and 158 are preferably software modules that comply with CORBA.

Portable interceptors are a standard CORBA mechanism for adding functionality to the request-processing capabilities of an ORB. A portable interceptor may be invoked by an ORB at predefined points in the request and reply paths of an operation invocation or during the generation of an interoperable object reference (IOR). A portable interceptor may be programmed to include instructions to be executed at each interception point to perform application-specific tasks.

The client ORB 154 and the server ORB 156 cooperate to enable communication between the application-client 112 and the first application 132. When the client ORB 154 detects a communication failure between the application-client 112 and the first application 132, it notifies the portable interceptor 152 of such failure. The communication failure may be caused, for example, by a disconnection within a TCP/IP socket being used by the application-client 112 and the first application 132. In response to being notified of the failure, the portable interceptor 152 contacts the LBB 120 and requests an interoperable object reference (IOR) associated with a duplicate application (i.e., an application that is substantially a copy of the first application 132). In general, an IOR comprises information identifying, among other things, an object, the TCP/IP (transmission control protocol/Internet protocol) port on which the object is monitoring packets, and the host on which an object resides.

An IOR may also include the name of the application comprising the object identified by the IOR. An application name may be inserted into an IOR to provide means for identifying an application and/or to indicate that a duplicate application comprising a duplicate object may exist. An IOR that comprises an application name may be marked with an application marker. An application marker may comprise predetermined character(s) that are placed at predetermined location(s) in the IOR. Prior to requesting a backup IOR from the LBB 120, the portable interceptor 152 may examine the IOR of the first object 134 to determine whether it comprises an application marker. If the portable interceptor 152 determines that the IOR of the first object 134 does not comprise an application marker, then it may forgo requesting a backup IOR from the LBB 120, and failover may not be implemented. If, on the other hand, the portable interceptor 152 determines that the IOR of the first object 134 comprises an application marker, then it may extract an application name from the IOR and provide the application name to the LBB 120 along with the request for the backup IOR.

In response to a receipt of a request for a backup IOR, the LBB 120 may provide the portable interceptor 152 with a backup IOR corresponding to the duplicate application 142. The backup IOR may correspond to a naming service module that is part of the backup application-server 140, and that serves the duplicate application 142. Furthermore, the backup IOR may have been provided to the LBB 120 by the backup application server 140 in response to a request by the LBB 120 for the backup IOR. The portable interceptor 152 replaces the host ID and port ID of the IOR of the first object 134 with the host ID and port ID, respectively, of the backup IOR to construct a failover IOR corresponding to the duplicate object 144. The failover IOR is then used by the portable interceptor 152 to forward a copy of a failed request to the duplicate object 144.

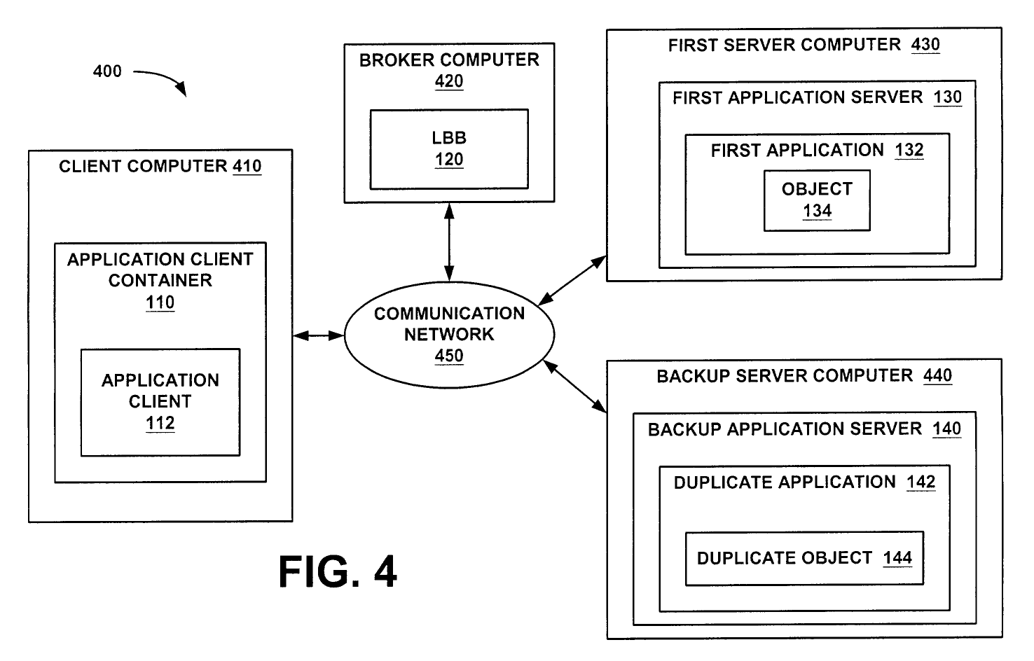

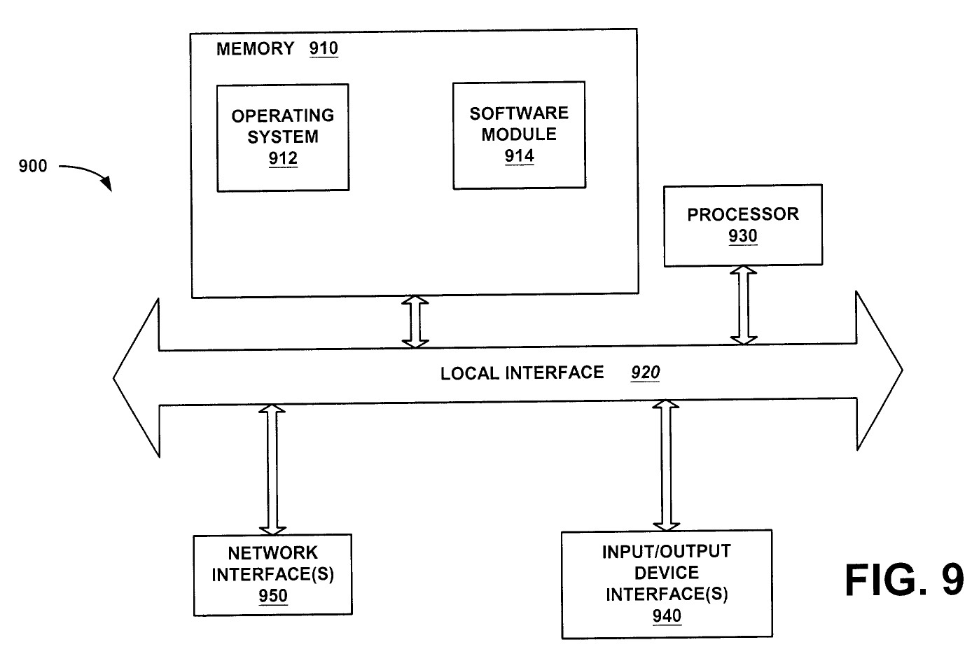

Reference is now directed to FIG. 4, which is a block diagram illustrating an embodiment of a computer network 400 for implementing the failover system 100 (FIG. 1). The computer network 400 comprises a client computer 410 for hosting the ACC 110, a broker computer 420 for hosting the LBB 120, a first server computer 430 for hosting the first application-server 130, and a backup server computer 440 for hosting the backup application-server 140. In an alternative embodiment, the ACC 110, the LBB 120, the first application-server 130, and/or the backup application-server 140 may be hosted by the same computer. Each of the computers 410, 420, 430, and 440 may be any instruction execution system, apparatus, or device now known or later developed. For example, one or more of the computers 410, 420, 430, and 440 may be generally configured as shown in FIG. 9.

The computers 410, 420, 430, and 440 are coupled to a communication network 450 which may be a local area network (LAN) or a wide area network (WAN). When the communication network 450 is a LAN, it may be, for example, a ring network, a bus network, or a wireless local network. When the communication network 450 is a WAN, it may be, for example, a public-switched telephone network (PSTN), a proprietary network, or the Internet. Data may be exchanged over the communication network 450 using communication protocols now known or later developed. For example, TCP/IP may be used if the communication network 450 is the Internet, or proprietary data communication protocols may be used if the communication network 450 is a proprietary LAN or WAN.

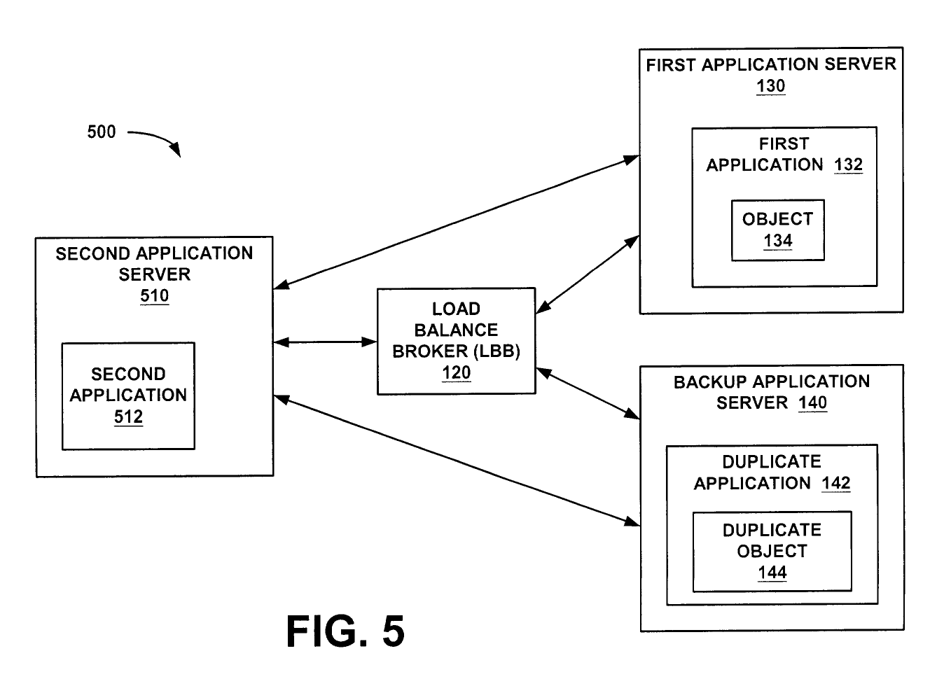

Reference is now directed to FIG. 5, which is a block diagram illustrating an embodiment of a failover system 500, according to the present invention. The failover system 500 comprises a first application-server 130, a second application-server 510, a backup application-server 140, a first application 132, a second application 512, a duplicate application 142, and a load balance broker (LBB) 120, all of which are preferably software entities that may be executed by respective computers. The first application-server 130 hosts a first application 132 comprising at least a first object 134. The backup application-server 140 hosts a duplicate application 142 that is substantially a copy of the first application 132. The duplicate application 142 comprises a duplicate object 144 that is substantially a copy of the first object 134.

The LBB 120 maintains a list of addresses for application-servers for the purpose of balancing workloads among the application-servers. The LBB 120 may enable failover by providing the second application-server 510 with an address for the duplicate application 142 when a communication between the second application 512 and the first object 134 fails. In an alternative embodiment, a software module other than the LBB 120 may be used to provide the second application-server 510 with an address for the duplicate application 142.

The first application-server 130 and the backup application-server 140 each host at least one respective application in accordance with a standard that is now known or later developed. In a preferred embodiment, the first application-server 130 and the backup application-server 140 are Java modules that function in accordance with J2EE.

The second application-server 510 implements failover in response to a communication failure between the second application 512 and the first object 134. The second application 512 may communicate with the first application 132 and/or the duplicate application 142 by following a protocol that is now known or later developed. In a preferred embodiment, the second application-server 510 communicates with the first object 134 and/or the duplicate object 144 via object request brokers (ORBs) that are compliant with a CORBA standard.

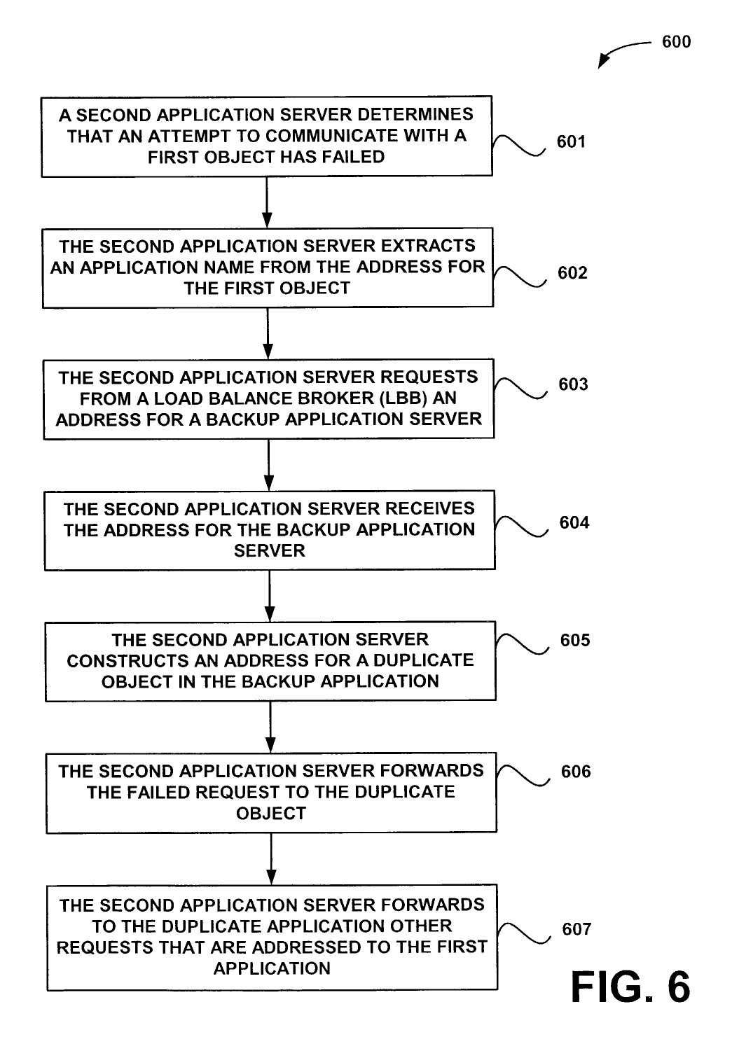

Reference is now directed to FIG. 6, which is a flow chart illustrating an embodiment of a failover method 600, according to the present invention. As shown in block 601, the second application-server 510 determines that an attempt by the second application 512 to communicate with the first object 134 has failed. In response to determining that the communication attempt has failed, the second application-server 510 extracts the name of the first application 132 from an address for the first object 134, as illustrated in block 602. Prior to extracting the name of the first application 132 from the address, the second application-server 510 may determine whether the address comprises such name by determining whether the address comprises an application marker.

After extracting the application name from the address for the first object 134, the second application-server 510 then requests from the LBB 120, as illustrated in block 603, a backup address corresponding to a duplicate application (i.e., an application that is substantially a copy of the first application 132). The duplicate application may be identified to the LBB 120 by the application name extracted from the address for the first object 134. In response to the request from the second application-server 510, the LBB 120 may provide the second applicationserver 510 with the requested backup address, which may be obtained by the LBB 120 from the backup application server 140. After the second application-server 510 receives the backup address, as illustrated in block 604, it uses the backup address to construct a failover address corresponding to a duplicate object 144 that is part of the duplicate application 142, as illustrated in block 605. After constructing the failover address, the second application-server 510 may then use it to forward a copy of a failed request to the duplicate object 144, as illustrated in block 606. Furthermore, the second application-server 510 may forward to the duplicate application 142 copies of other requests from the second application 512 that are addressed to the first application 132, as illustrated in block 607.

Any process descriptions or blocks in the flow charts presented in FIGS. 2 & 6 should be understood to represent modules, segments, or portions of code or logic, which include one or more executable instructions for implementing specific logical functions or steps in the associated process. Alternate implementations are included within the scope of the present invention in which functions or steps may be omitted or implemented out of order from that shown or discussed. For example, functions or steps may be implemented substantially concurrently or in reverse order, depending on the functionality involved, as would be understood by those reasonably skilled in the art after having become familiar with the teachings of the present invention.

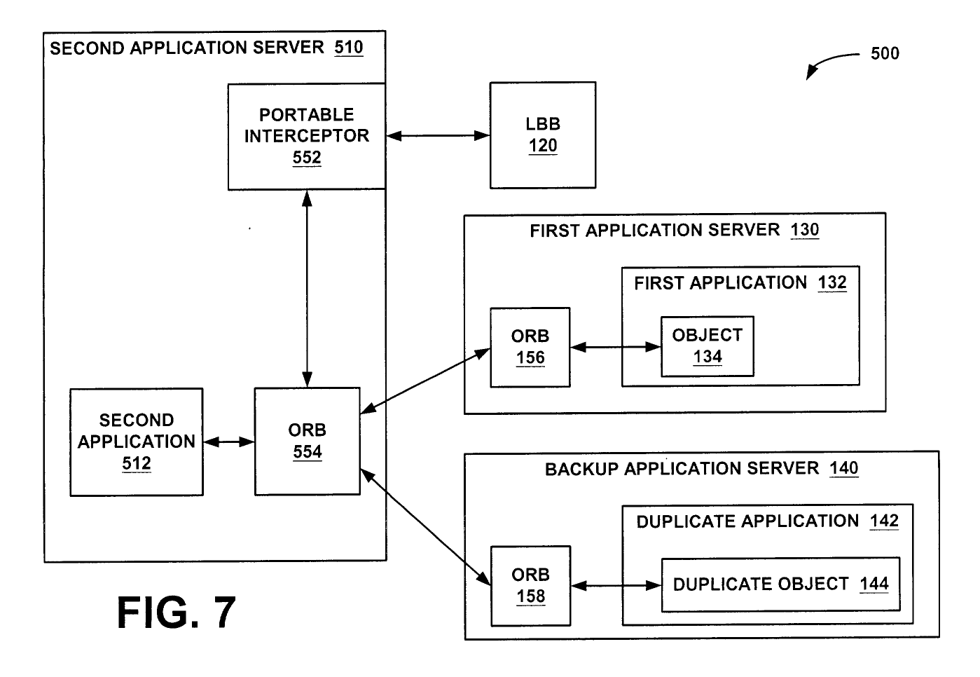

Reference is now directed to FIG. 7, which is a block diagram illustrating an example of a specific implementation of the failover system 500. The second application-server 510 comprises a portable interceptor 552 and an ORB 554 for providing services to the second application 512. The portable interceptor 552 and the ORB 554 are preferably software modules that comply with CORBA. The ORB 554, in cooperation with another ORB (e.g., ORB 156 or 158), handles the communication of messages between the second application 512 and a remote application (e.g., the first application 132 or the duplicate application 142). Furthermore, the ORB 554 cooperates with the portable interceptor 552 to enable failover. For example, when the ORB 554 detects a communication failure between the second application 512 and the first application 132, it notifies the portable interceptor 552 of such failure. In response to being notified of the failure, the portable interceptor 552 contacts the LBB 120 and requests an IOR associated with a duplicate application (i.e., a copy of the first application 132).

Prior to requesting an IOR from the LBB 120, the portable interceptor 552 may examine the IOR of the first object 134 to determine whether it comprises an application marker. If the portable interceptor 552 determines that the IOR of the first object 134 does not comprise an application marker, then it may forgo requesting an IOR from the LBB 120, and failover may not be implemented. If, on the other hand, the portable interceptor 552 determines that the IOR of the first object 134 comprises an application marker, then it may extract the application name from the IOR and provide the application name to the LBB 120 along with the request for a backup IOR.

In response to the request, the LBB 120 may provide the portable interceptor 552 with a backup IOR corresponding to the duplicate application 142. The backup IOR may correspond to a naming service module that is part of the backup application-server 140, and that serves the duplicate application 142. Furthermore, the backup IOR may have been provided to the LBB 120 by the backup application server 140 in response to a request by the LBB 120 for the backup IOR. The portable interceptor 552 replaces the host ID and port ID of the IOR of the first object 134 with the host ID and port ID, respectively, of the backup IOR to construct a failover IOR corresponding to the duplicate object 144. The failover IOR is then used by the portable interceptor 552 to forward a copy of a failed request to the duplicate object 144.

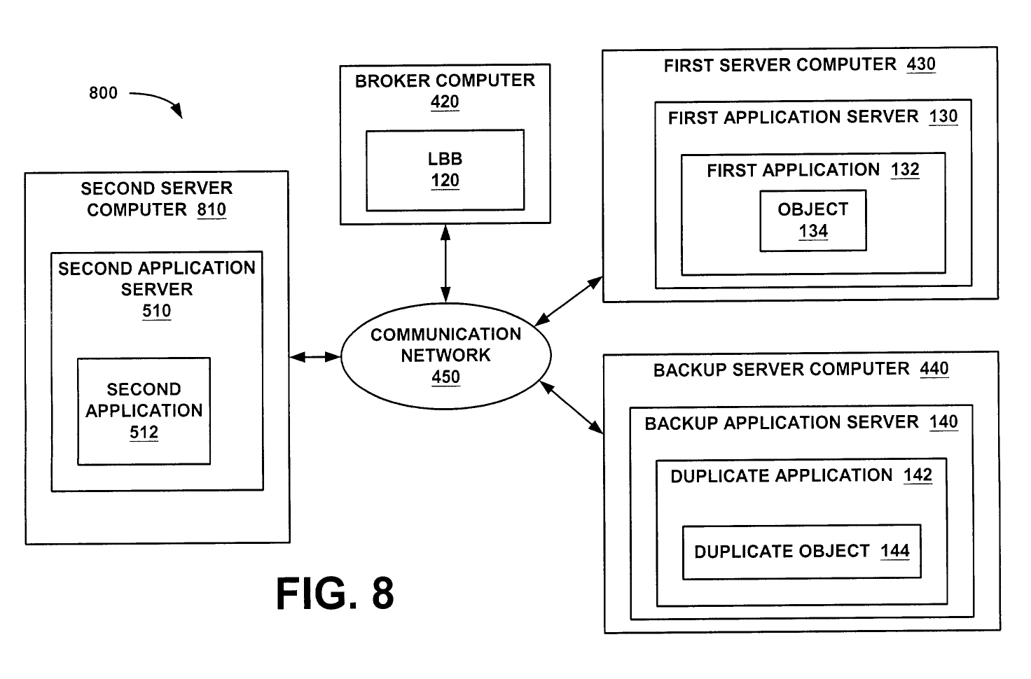

Reference is now directed to FIG. 8, which is a block diagram illustrating an embodiment of a computer network 800 for implementing the failover system 500 (FIG. 5). The computer network 800 comprises a second server computer 810 for hosting the second application server 510, a broker computer 420 for hosting the LBB 120, a first server computer 430 for hosting the first application-server 130, and a backup server computer 440 for hosting the backup application-server 140. In an alternative embodiment, the second application server 510, the LBB 120, the first application-server 130, and/or the backup application-server 140 may be hosted by the same computer. Each of the computers 810, 420, 430, and 440 may be any instruction execution system, apparatus, or device now known or later developed. For example, one or more of the computers 810, 420, 430, and 440 may be generally configured as shown in FIG. 9.

The computers 810, 420, 430, and 440 are coupled to a communication network 450 which may be a local area network (LAN) or a wide area network (WAN). When the communication network 450 is a LAN, it may be, for example, a ring network, a bus network, or a wireless local network. When the communication network 450 is a WAN, it may be, for example, a public-switched telephone network (PSTN), a proprietary network, or the Internet. Data may be exchanged over the communication network 450 using communication protocols now known or later developed. For example, TCP/IP may be used if the communication network 450 is the Internet, or proprietary data communication protocols may be used if the communication network 450 is a proprietary LAN or WAN.

Reference is now directed to FIG. 9, which is a functional block diagram illustrating an embodiment of a computer 900 that may be used to store and execute any software implementations of the present invention. Generally, in terms of hardware architecture, the computer 900 may comprise a processor 930, memory 910, input/output device interface(s) 940, and network interface(s) 950, all of which may be communicatively coupled via a local interface 920. The local interface 920 can be, for example, among others, one or more buses or other wired or wireless connections, as is known in the art or may be later developed. The local interface 920 may have additional elements, which are omitted for simplicity, such as controllers, buffers (caches), drivers, repeaters, and/or receivers, to enable communications.

In the embodiment of FIG. 9, the memory 910 can comprise any one or combination of volatile memory elements (e.g., random access memory (RAM, such as dynamic RAM or DRAM, static RAM or SRAM, etc.)) and nonvolatile memory elements (e.g., read-only memory (ROM), hard drives, tape drives, compact discs (CD-ROM), etc.). Moreover, the memory 910 may incorporate electronic, magnetic, optical, and/or other types of storage media now known or later developed. Note that the memory 910 can have a distributed architecture, where various components are situated remote from one another, but can be accessed by the processor 930.

The processor 930 may be any custom-made or commercially-available processor. Furthermore, the processor may be a central processing unit (CPU) or an auxiliary processor among several processors associated with the computer 900. When the computer 900 is in operation, the processor 930 is configured to execute software stored within the memory 910, to communicate data to and from the memory 910, and to generally control operations of the computer 900 pursuant to the software.

The computer 900 may also comprise input/output device interface(s) 940 and network interface(s) 950. The input/output device interface(s) 940 comprise one or more interfaces for communicating via one or more input and/or output devices, such as, for example, among others, a keyboard, a mouse, a microphone, a printer, a multi-function device, a monitor, and/or an external speaker, etc. The network interface(s) 950 may comprise one or more devices that can be used to communicate with other computers. The network interface(s) 950 may comprise, for example, among others, a modem, a radio frequency (RF) or other transceiver, a telephonic interface, a bridge, and/or an optical interface, a router, etc.

The software in memory 910 may comprise one or more software applications, each of which comprises executable instructions for implementing logical functions. In the example of FIG. 9, the software in the memory 910 comprises an operating system 912 and at least one software module 914. The operating system 912 preferably controls the execution of other computer programs, such as the software module 914, and provides scheduling, input/output control, file and data management, memory management, and communication control and related services. Depending on a desired implementation, the software module 914 may be, for example, the application-client container 110, the LBB 120, the first application-server 130, the second application-server 510, or the backup application-server 140.

In a preferred embodiment, software module 914 comprises one or more source programs, executable programs (object code), scripts, and/or other software modules each comprising a set of instructions to be performed. Furthermore, software module 914 may be written in (a) an object-oriented programming language, which has classes of data and methods, or in (b) a procedure programming language, which has routines, subroutines, and/or functions. It will be well-understood by one skilled in the art, after having become familiar with the teachings of the invention, that software module 914 may be written in a number of programming languages now known or later developed.

The software module 914 can be embodied in any computer-readable medium for use by or in connection with an instruction execution system, apparatus, or device, such as a computer-based system or a processor-containing system. In the context of this disclosure, a “computer-readable medium” can be any means that can store, communicate, propagate, or transport a program for use by or in connection with the instruction execution system, apparatus, or device. The computer-readable medium can be, for example, among others, an electronic, magnetic, optical, electromagnetic, infrared, or semiconductor system, apparatus, device, or propagation medium now known or later developed.

What is claimed is:

1. A method for enabling failover comprising:
determining that an attempt to communicate with a first object having a first address has failed, the first object being a part of a first application hosted by a first application-server;
requesting a backup address associated with a duplicate application that is substantially a copy of the first application, the duplicate application comprising a duplicate object that is substantially a copy of the first object;
receiving the backup address; and
using a portion of the first address and a portion of the backup address to construct a failover address for the duplicate object.

2. The method of claim 1, further comprising:
communicating with the duplicate object using the failover address for the duplicate object.

3. The method of claim 1, further comprising:
prior to requesting the backup address, determining whether the first address comprises a name of the first application.

4. The method of claim 3, wherein requesting the backup address is responsive to determining that the first address comprises the name of the first application.

5. The method of claim 3, wherein determining whether the first address comprises the name of the first application is based on whether the first address comprises an application marker.

6. The method of claim 1, wherein using a portion of the first address and a portion of the backup address to construct a fai lover address for the duplicate object comprises including an object identifier (ID) that is part of the first address and a host ID and a port ID that are part of the backup address in the failover address for the duplicate object.

7. The method of claim 1, wherein using a portion of the first address and a portion of the backup address to construct a failover address for the duplicate object comprises modifying the first address by replacing a host identifier (ID) and a port ID that are used in the first address with a host ID and a port ID, respectively, that are used in the backup address.

8. A method for enabling failover, comprising:
attempting to communicate with a first object using a first address comprising a first object ID, the first object being part of a first application hosted by a first application-server;
determining that attempting to communicate with the first object has failed; and
communicating with a duplicate object using a failover address comprising the first object identifier (ID), the duplicate object being part of a duplicate application hosted by a backup application-server.

9. The method of claim 8, further comprising:
prior to communicating with the duplicate object, requesting a backup address associated with the duplicate application;
receiving the backup address; and
using a portion of the first address and a portion of the backup address to construct the failover address.

10. The method of claim 9, further comprising:
prior to requesting the backup address, determining whether the first address comprises a name of the first application.

11. The method of claim 10, wherein requesting the backup address is responsive to determining that the first address comprises the name of the first application.

12. The method of claim 10, wherein determining whether the first address comprises the name of the first application is based on whether the first address comprises an application marker.

13. The method of claim 9, wherein using a portion of the first address and a portion of the backup address to construct a failover address for the duplicate object comprises including an object identifier (ID) that is part of the first address and a host ID and a port ID that are part of the backup address in the failover address for the duplicate object.

14. The method of claim 8, wherein using a portion of the first address and a portion of the backup address to construct a failover address for the duplicate object comprises modifying the first address by replacing a host identifier (ID) and a port ID that are used in the first address with a host ID and a port ID, respectively, that are used in the backup address.

15. A system for enabling failover, comprising:
means for determining that an attempt to communicate with a first object has failed, the first object having a first address comprising a first object identifier (ID) and being part of a first application hosted by a first application-server; and
means for constructing a failover address for a duplicate object having a same object ID as the first object, the duplicate object being part of a duplicate application hosted by a backup application-server.

16. The system of claim 15, wherein the failover address comprises an interoperable object reference (IOR).

17. The system of claim 15, further comprising:
means for communicating with the duplicate object using the failover address comprising the first object ID.

18. The system of claim 15, wherein the means for determining comprises an object request broker (ORB).

19. The system of claim 15, wherein the means for constructing comprises a portable interceptor.

20. A method for enabling failover, comprising:
assigning a first object identifier (ID) to a first object that is part of a first application; and
assigning a same object ID as the first object ID to a duplicate object that is part of a duplicate of the first application.

21. The method of claim 20, further comprising:
hosting the first application using a first application-server; and
hosting the duplicate of the first application using a second application-server.

22. The method of claim 20, further comprising:
attempting to communicate with the first object by using a first address comprising the first object ID.

23. The method of claim 20, further comprising:
communicating with the second object by using a failover address comprising the first object ID in response to a failed attempt to communicate with the first object.

24. A system for enabling failover comprising:
an object request broker (ORB) that is configured to direct a first request to a first object by using a first address;
a portable interceptor that is configured to provide the ORB with a failover address for a duplicate object in response to being notified by the ORB that the request to the first object has failed.

25. The system of claim 24, wherein the ORB is configured to determine whether the request has failed to be implemented by the first object.

26. The system of claim 24, wherein the portable interceptor is configured to instruct the ORB to direct a copy of the first request to the duplicate object using the failover address.

27. The system of claim 24, wherein the failover address comprises an interoperable object reference (IOR).
